(19) United States
(12) Patent Application Publication
(10) Pub. No.: US 2011/0107325 A1
(43) Pub. Date: May 5, 2011

(54) Early Detection of Errors in a Software Installation

(76) Inventors: Jack Matthew, San Francisco, CA (US); Kevin Tiene, Cupertino, CA (US)

(21) Appl. No.: 12/611,765

(22) Filed: Nov. 3, 2009

(51) Int. Cl. G06F 9/445

(52) U.S. Cl. 717/174; 714/E11.04

(57) ABSTRACT

A method and apparatus for the installation of software is described herein. In one embodiment, a process is provided to verify a first set of packages selected from all packages, for example, on an optical disk, and verify a second set of packages on the optical disk. The verifying of the first set of packages calculates a first checksum for each package in the first set of packages and compares this first checksum to a second checksum for each package read from the optical disk. A second set of packages is verified if the verification of the first packages is successful. The second set of packages is verified by copying each package in the second set of packages, from the optical disk. A third checksum is included with each package read, and this third checksum is compared with a fourth checksum calculated for each package.

### FIELD OF THE INVENTION

The field of invention can relate generally to computing systems, and, more specifically, to early detection of errors in a software installation.

### BACKGROUND

Optical disks are used to install software programs. These optical disks do not always function properly. The optical disks can be faulty due to a manufacturing process problem or may not be supported by the optical disk drive used to read the disk. Furthermore, the optical disk drive used to read the optical disk may be a bad drive or may have been unused for a long time and collected dust or other impurities, thereby rendering the drive unusable or unreliable.

Prior to installing one or more software programs from an optical disk, the optical disk should be verified to determine whether the optical disk or the optical disk drive is usable. Otherwise, the installation of the software will not work or the software may be incorrectly installed if there is a bad read from the optical disk. One manner of completely verifying that a file is in the required condition to be installed is described in U.S. Pat. No. 7,530,065, issued to Cuidad et al., the disclosure of which is hereby incorporated by reference as if fully set forth herein.

### SUMMARY OF THE DESCRIPTION

Mechanisms for installation of software are described herein. In one embodiment, a process can be provided to verify a first set of packages selected from all packages on the optical disk and verify a second set of packages on the optical disk. The verification of the first set of packages can calculate a first checksum for each package in the first set of packages and compare this first checksum to a second checksum for each package read from the optical disk. A second set of packages can be verified if the verification of the first packages is successful. The second set of packages can be verified by copying each package in the second set of packages from the optical disk. A third checksum can be included with each package read, and this third checksum can be compared with a fourth checksum calculated for each package. Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates an exemplary system architecture including an optical disk drive in which embodiments of the present invention may operate;

FIG. 2 illustrates a block diagram of an exemplary computer system in which embodiments of the present invention may operate;

FIG. 3 illustrates an exemplary memory in accordance with FIG. 2;

FIG. 4 illustrates a flow diagram of a software installation method in accordance with embodiments of the present invention;

FIG. 5 illustrates a flow diagram of a software installation method in accordance with embodiments of the present invention;

FIG. 6 illustrates a flow diagram of a verification of a subset of packages in accordance with embodiments of the present invention; and

FIG. 7 illustrates a flow diagram of a verification of a set of packages in accordance with embodiments of the present invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Software (e.g., on an optical disk) can be verified before the software is installed onto a computer system. In one embodiment, software verification can be accomplished in a two-stage process. If verification in the first phase is unsuccessful, then the computer system can notify the user before additional time and resources are committed to the installation. In one embodiment, a first set of packages comprising the software can be verified by calculating a checksum (or other representation of data) for each package and comparing that checksum (or other representation of data) to a checksum (or other representation of data) read from the optical disk for that package. A second set of packages can be verified if the verification of the first packages is successful. The second set of packages can be verified by copying each package in the second set of packages from the optical disk to the computer system. Each package copied can include a checksum (or other representation of data). The computer system can calculate a new checksum (or other representation of data) for each package and compare it to the checksum (or other representation of data) included in each package. The software can be installed upon a successful verification of all the packages in the second set of packages.

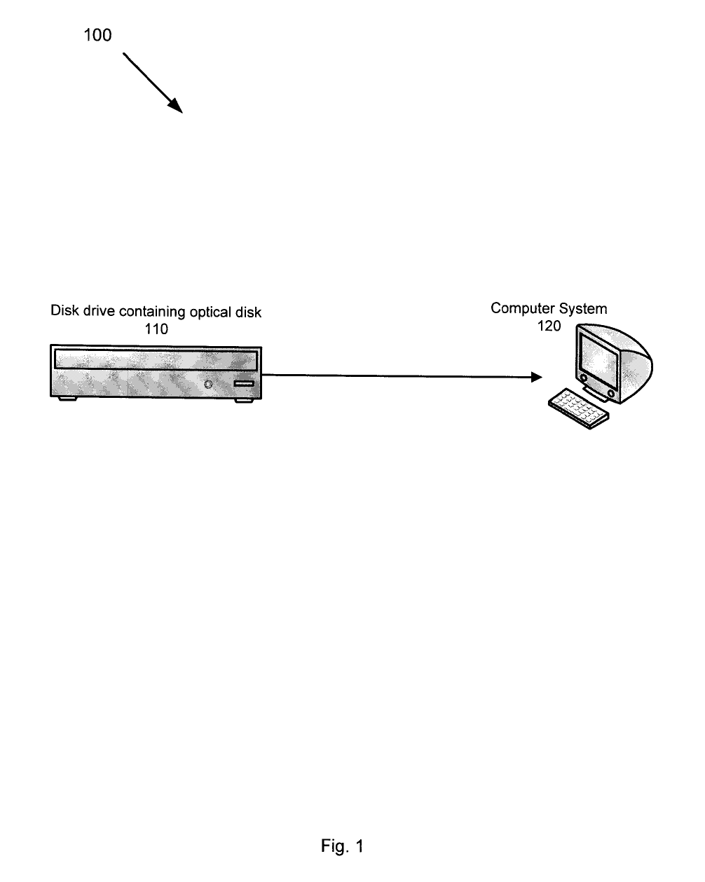

FIG. 1 shows a system architecture 100 in which the verifications described above may be performed. System architecture 100 includes disk drive 110 and computer system 120. Disk drive 110 contains an optical disk on which software is stored. In general, an optical disk is used to install a software program. However, an optical disk does not always function properly. The optical disk can be faulty due to a manufacturing process problem or may not be supported by the disk drive 110 used to read the optical disk. Furthermore, the disk drive 110 used to read the optical disk may be a bad drive or may have been unused for a long time and collected dust or other impurities, thereby rendering the disk drive 110 unusable or unreliable.

In one embodiment of the present invention, disk drive 110 can communicate with computer system 120 in any number of protocols. For example, disk drive 110 can be an internal disk drive for computer system 120, connected via an Advanced Technology Attachment (ATA) or Serial Advanced Technology Attachment (SATA) interface. In an alternate embodiment of the present invention, disk drive 110 is connected to computer system 120 via a Universal Serial Bus (USB), a IEEE 1394 interface such as FireWire™ available from Apple, Inc. of Cupertino, Calif., or a Small Computer System Interface (SCSI). In yet another embodiment of the present invention, disk drive 110 communicates with computer system 120 via one or more networks. The networks may include a LAN, WAN, intranet, extranet, wireless network, the Internet, etc.

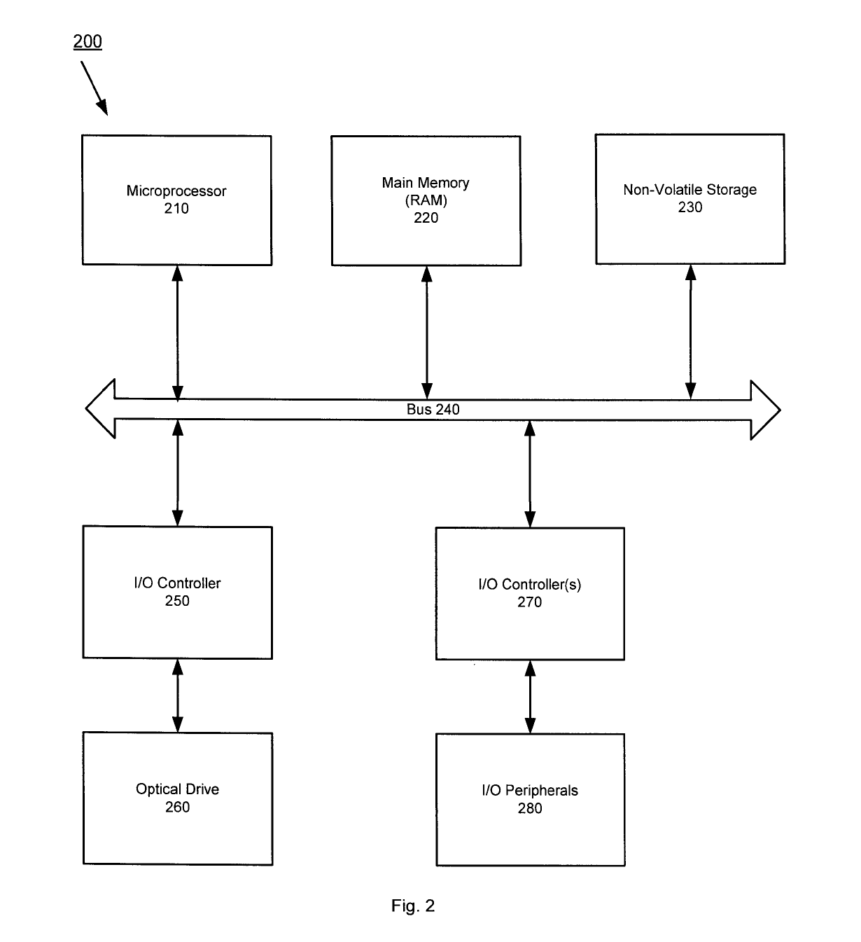

FIG. 2 is a block diagram of an exemplary computer system in which embodiments of the present invention may operate. Computer system 200 includes microprocessor 210, main memory (RAM) 220, non-volatile storage 230, bus 240, I/O controller 250, optical drive 260, I/O controller 270, and I/O peripherals 280.

Main memory 220 encompasses all volatile or non-volatile storage media, such as dynamic random access memory (DRAM), static RAM (SRAM), or flash memory. Main memory 220 includes storage locations that are addressable by the microprocessor 210 for storing computer program code and data structures for the verification of the software to be installed. Such computer program code and data structures also may be stored in non-volatile storage 230. Non-volatile storage 230 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 220. Those skilled in the art will immediately recognize that the term “computer-readable storage medium” or “machine readable storage medium” includes any type of volatile or non-volatile storage device that is accessible by a processor (including main memory 220 and non-volatile storage 230).

Microprocessor 210 is coupled to main memory 220 and non-volatile storage 230 through bus 240. Microprocessor 210 includes processing elements and/or logic circuitry configured to execute the computer program code and manipulate the data structures. It will be apparent to those skilled in the art that other processing and memory means, including various computer readable storage media, may be used for storing and executing computer program code pertaining to verifying the software to be installed.

Microprocessor 210 can retrieve instructions from main memory 220 and non-volatile storage 230 via bus 240 and execute the instructions to perform operations described below. Bus 240 is coupled to I/O controller 250, I/O controller 250 is also coupled to optical drive 260. Optical drive 260 contains the optical disk with the software to be installed on computer system 200.

Bus 240 is further coupled to I/O controller(s) 270. I/O controller(s) 270 are coupled to I/O peripherals 280, which may be mice, keyboards, modems, network interfaces, printers and other devices which are well known in the art.

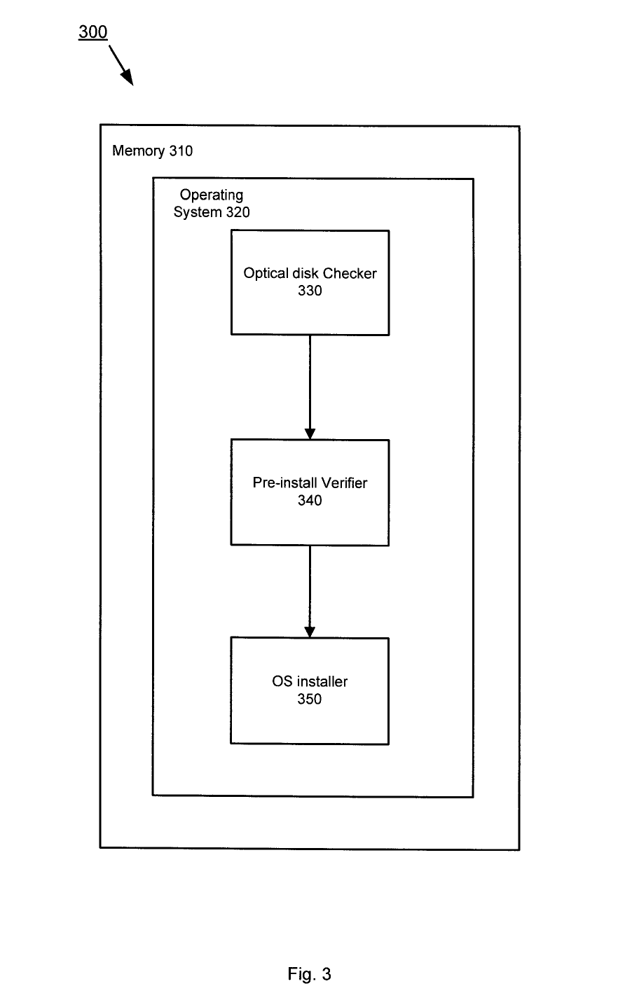

FIG. 3 illustrates an exemplary main memory 220 of FIG. 2. Referring to FIG. 3, memory 310 contains an operating system 320. Within operating system 320, there is an optical disk checker 330, a pre-install verifier 340, and an OS installer 350. In other embodiments, the software components 330, 340, and 350 can be separate from and not part of an operating system.

Optical disk checker 330 can detect a request to install software from an optical disk. In one embodiment, packages can be obtained from the optical disk. In one embodiment, the packages can contain the software to be installed from the optical disk. In one embodiment, tiles on the optical disk can contain the software and these files may be compressed in the packages. In one embodiment, the packages can contain metainfo. In this embodiment, the metainfo can track the software to be installed and may also track the software that has already been installed. In one embodiment, each package may contain package information, which can describe the contents of the package. In one embodiment, the contents of the package can contain a payload, which can be the compressed representation of all software files to be installed. In one embodiment, the software can be an operating system.

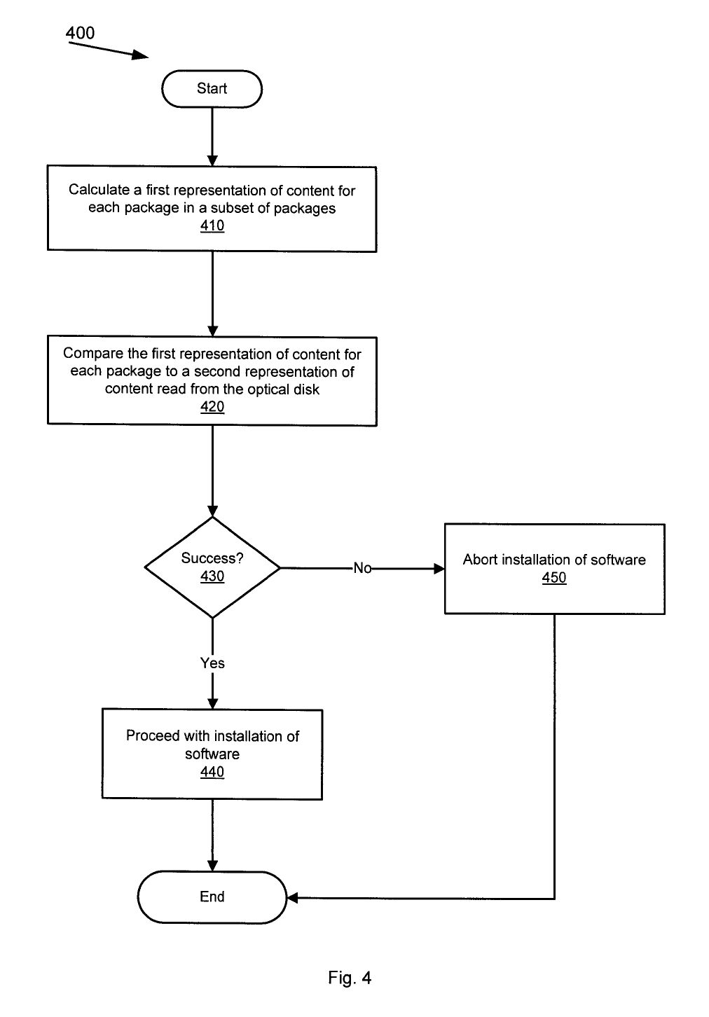

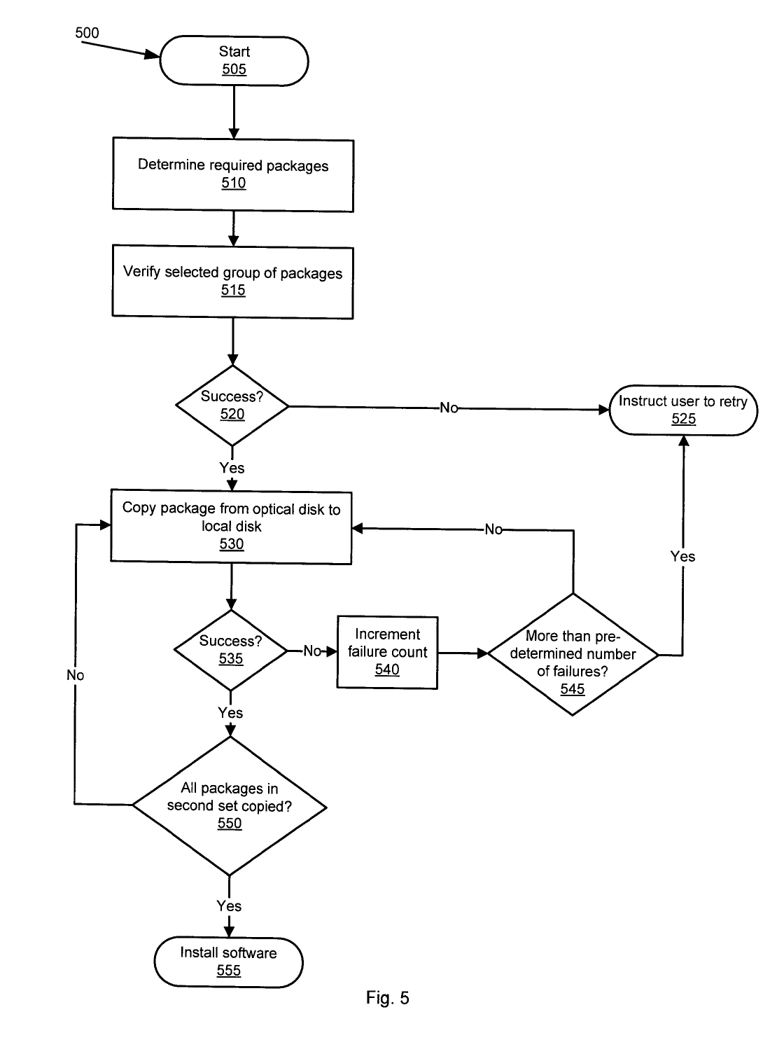

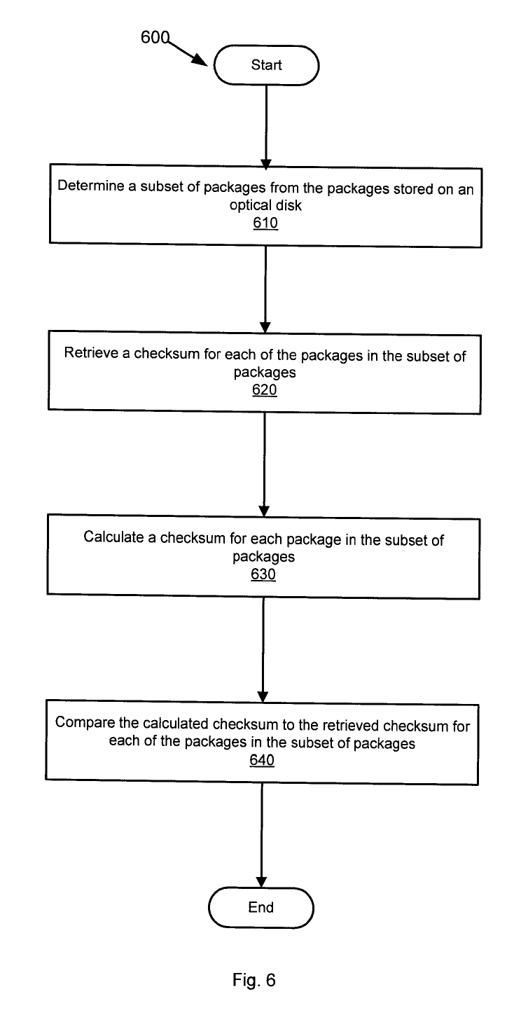

Optical disk checker 330 determines a first set of packages from the optical disk. In one embodiment, the first set of packages can be a subset of all packages (less than all packages) on the optical disk. In one embodiment, the first set of packages cart be identified in a header file stored on the optical disk. In one embodiment, the header file can be a table of contents of the packages on the optical disk, including the locations on the optical disk at which the packages are located. In an alternate embodiment, the first set of packages can be stored on the optical disk as, or identified in, one or more scripts. The verification of the first set of packages in described below in conjunction with FIG. 4, FIG. 5, and FIG. 6. In one embodiment, if the verification of the first set of packages is successful, optical disk checker 330 sends a successful completion notice to pre-install verifier 340.

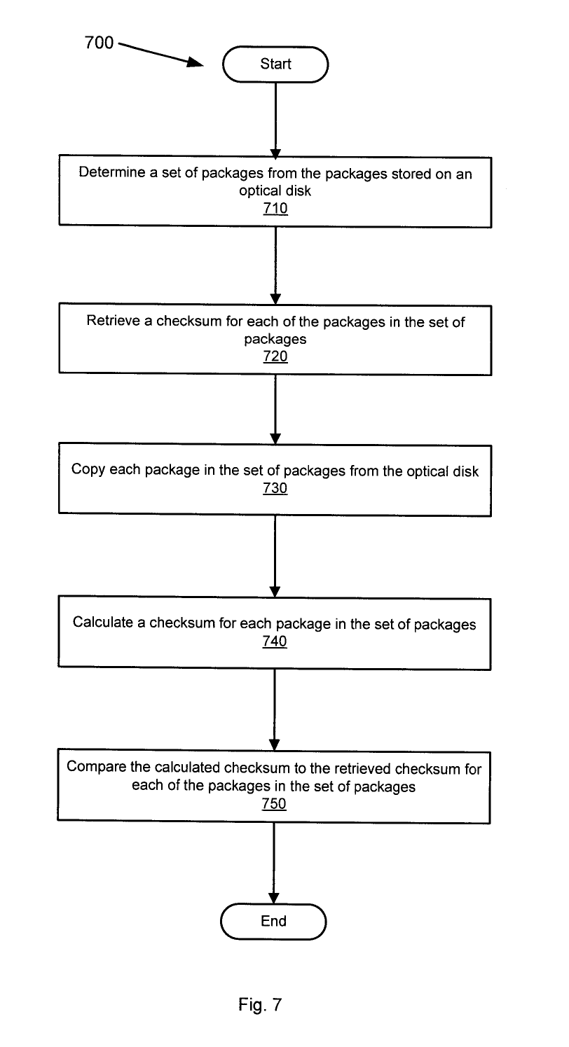

Upon receiving a successful completion notice from optical disk checker 330, pre-install verifier 340 verifies a second set of packages on the optical disk. In one embodiment, the second set of packages can be all of the packages on the optical disk. In an alternate embodiment, the second set of packages can be a subset of the packages on the optical disk. In one embodiment, pre-install verifier 340 can copy the second set of packages into memory 310 prior to verifying the second set of packages. In an alternate embodiment, pre-install verifier 340 can copy a package in the second set of packages into a buffer, verify the package, and then copy the package into memory 310. In this embodiment, the buffer may or may not be part of memory 310. The verification of the second set of packages is described below in conjunction with FIG. 4, FIG. 5, and FIG. 7. If the verification of the second set of packages is successful, the pre-install verifier sends a successful completion notice to OS installer 350.

Upon receiving a successful completion notice from pre-install verifier 340, OS installer 350 installs the software. In one embodiment, OS installer 350 can install the software as stored by pre-install verifier 340 in memory 310. In an alternate embodiment, OS installer 350 can install the software from the optical disk.

FIG. 4 illustrates an exemplary flow diagram of a software installation method in accordance with embodiments of the present invention. In one embodiment, software installation method 400 is performed by optical disk checker 330.

At block 410, a first representation of content (e.g., a checksum, a hash value, or other known representations of content) is calculated for each package in a subset of packages. In one embodiment, the subset of packages can be selected from all packages stored on an optical disk. In this embodiment, the number of packages in the subset can be smaller than the total number of packages on the optical disk. In one embodiment, the subset of packages can be stored on the optical disk as a first set of packages. In one embodiment, the required packages can be identified in the optical disk as a header file stored on the optical disk. In one embodiment, the header file can be a table of contents of the packages on the optical disk, including the locations on the optical disk at which the packages are located. In an alternate embodiment, the required packages can be stored on the optical disk as, or identified in, one or more scripts. The first representation of content can be any one of a hash key, an error correction code (ECC), a cyclic redundancy check (CRC), a checksum, a parity, or any other equivalent representation.

At block 420, the first representation of content is compared to a second representation of content for the corresponding package. In one embodiment, the second representation of content can be stored on and read from the optical disk for each package. The second representation of content can be any one of a hash key, an error correction code (ECC), a cyclic redundancy check (CRC), a checksum, a parity, or any other equivalent representation.

At block 430, a determination is made as to whether the comparison for every package in the subset of packages performed at block 420 was successful. If all comparisons were successful, the process continues to block 440, where the process proceeds with installation of the software from the optical disk.

If the determination at block 430 shows one or more unsuccessful comparisons at block 420, the process continues to block 450. At block 450, the installation of the software from the optical disk is aborted. In one embodiment, the user can be asked to perform an action upon the abortion of the installation. In one embodiment, the user can be asked to retry the installation of the software upon abortion of the installation. In an alternate embodiment, the installation of the software can be automatically retried a predetermined number of times before the installation of the software is aborted.

FIG. 5 illustrates an exemplary flow diagram of a software installation method in accordance with embodiments of the present invention. In one embodiment, software installation method 400 is performed by optical disk checker 330 and pre-install verifier 340.

Referring to FIG. 5, method 500 starts at block 505. At block 510, the process determines required packages for verifying the optical disk. In one embodiment, packages can be obtained from the optical disk. In one embodiment, the packages can contain the software to be installed from the optical disk. In one embodiment, files on the optical disk can contain the software and these files may be compressed in the packages. In one embodiment, the packages can contain metainfo. In this embodiment, the metainfo can track the software to be installed and may also track the software that has already been installed. In one embodiment, each package may contain package information, which can describe the contents of the package. In one embodiment, the contents of the package can contain a payload, which can be the compressed representation of all software files to be installed. In one embodiment, the software can be an operating system. In one embodiment, the required packages are a first set of packages selected from all packages stored on an optical disk. In this embodiment, the number of required packages can be less than the total number of packages on the optical disk. In an alternate embodiment, the required packages can be a subset of a second set of packages stored on the optical disk. In one embodiment, the required packages can be identified in a header file stored on the optical disk. In one embodiment, the header file can be a table of contents of the packages on the optical disk. In an alternate embodiment, the required packages can be stored on the optical disk, or identified in, as one or more scripts.

At block 515, a selected group of packages are verified. In one embodiment, the selected group of packages can include all required packages determined at block 510. In an alternate embodiment, the selected group of packages can be a subset of the required packages determined at block 510. The verification of the selected group of packages is described below in conjunction with FIG. 6.

At block 520, the process determines whether the verification of the selected group of packages was successful. If the verification is not successful, the process continues to block 525. At block 525, the user is instructed to perform an action, and the process ends. In one embodiment, the user can be instructed to retry the installation of the software from the optical disk. In one embodiment, if the verification is not successful, the optical drive which is reading the disk may be damaged, malfunctioning, or may not have been used for a long period of time. In an alternate embodiment, if the verification was not successful, the optical disk on which the software is stored may be damaged or malfunctioning. In an alternate embodiment, the installation of the software can be automatically retried a predetermined number of times before the user can be instructed to perform an action.

In one embodiment, if the verification is successful at block 520, the process continues to block 530. At block 530, a package in a second set of packages is copied from the optical disk to the local disk. In an alternate embodiment, the package in the second set of packages can be read from the optical disk to the local disk without copying the package to the local disk. In one embodiment, the second set of packages can include all packages on the disk. In an alternate embodiment, the second set of packages can include a subset of the packages on the disk. In yet another embodiment, the second set of packages can be a predetermined set of installer packages. The installer packages are stored on the optical disk and are the only packages required by the operating system to install the software stored on the optical disk.

At block 535, the process determines if the copy from the optical disk to the local disk was successful. In one embodiment, the copy from the optical disk to the local disk can be determined to be successful by using the process described below in conjunction with FIG. 7.

If the copy from the optical disk to the local disk is not successful, the process proceeds to block 540 where a failure count is incremented. In one embodiment, the failure count can indicate the number of times that the current package has failed to copy. In an alternate embodiment, the failure count can indicate the number of times that all packages read from the optical disk have failed to copy.

At block 545, a determination is made as to whether the failure count compares in a predetermined manner to a predetermined number (e.g., greater than). In one embodiment, the predetermined number of failures can be 3. In alternate embodiments, the predetermined number of failures can be less than or greater than 3. In one embodiment, the predetermined number can be set by the software stored on the optical disk. In another embodiment, the predetermined number can be set by the operating system of the computer.

If the failure count is greater than the predetermined number, the user is instructed to perform an action at block 525, and the process ends. In one embodiment, the user can be instructed to retry the installation of the software from the optical disk.

If the failure count is not greater than the predetermined number, the process returns to block 530. In one embodiment, at block 530, the process can copy the same package as previously attempted. In an alternate embodiment, the process can copy the next package in the set of packages from the optical disk at block 530.

If the copy from the optical disk to the local disk is successful, meaning that the local disk stores a copy of the package, the process determines block 550 whether all packages in a second set of packages have been copied.

If the determination at block 550 determines all packages in the second set of packages have been copied, the software is installed at block 555 and the process ends. In one embodiment, the software can be installed using the second set of packages copied to the local disk. In an alternate embodiment, the software can be installed using packages located on the optical disk. In one embodiment, the software installation can require the computer on which the software is to be installed to restart using an installation operating system environment. In one embodiment, the software to be installed can be an operating system for a data processing system such as a computer.

If the determination at block 550 determines all packages in the second set have not been copied, the process returns to block 530 to copy the next package from the optical disk to the local disk and proceeds from block 530 as described above.

In certain embodiments, blocks 510, 515, and 520 are optional and are not performed. In certain embodiments, if blocks 510, 515, and 520 are omitted, the process continues to block 530 from block 505.

FIG. 6 illustrates a flow diagram of a verification of a subset of packages. In one embodiment, verification method 600 is performed by optical disk checker 330 of FIG. 3.

Referring to FIG. 6, block 610 determines a subset of packages from the packages stored on an optical disk. In one embodiment, the packages can contain the software to be installed from the optical disk. In one embodiment, files on the optical disk can contain the software and these files may be compressed in the packages. In one embodiment, the packages can contain metainfo. In this embodiment, the metainfo can track the software to be installed and may also track the software that has already been installed. In one embodiment, each package may contain package information, which can describe the contents of the package. In one embodiment, the contents of the package can contain a payload, which can be the compressed representation of all software files to be installed. In one embodiment, the software can be an operating system. In one embodiment, the subset of packages can be a first set of packages selected from all packages stored on an optical disk. In this embodiment, the number of required packages can be less than the total number of packages on the optical disk. In an alternate embodiment, the subset of packages can be a subset of a second set of packages stored on the optical disk. In one embodiment, the subset of packages can be identified in a header file stored on the optical disk. In one embodiment, the header file can be a table of contents of the packages on the optical disk. In an alternate embodiment, the subset of packages can be stored on the optical disk as, or identified in, one or more scripts.

At block 620, the process retrieves a checksum (or other representation of data) for each of the packages in the subset of packages. In one embodiment, the checksum (or other representation of data) can be retrieved from the optical disk as part of each package. In an alternate embodiment, the checksum (or other representation of data) can be retrieved from a different location on the optical disk than the package.

The process proceeds to block 630, where a checksum is calculated for each package in the subset of packages. In alternate embodiments, a representation of content other than a checksum may be used (such as, for example, a hash key, an error correction code, a cyclic redundancy check, a parity, etc) without departing from the scope of the invention.

At block 640, the checksum calculated at block 630 is compared to the checksum retrieved at block 620. In one embodiment, the verification of the subset of packages can be considered successful if the calculated checksum and the retrieved checksum are equivalent for each package in the subset of packages. In an alternate embodiment, the verification of the subset of packages can be considered successful if the calculated checksum and the retrieved checksum compares in a predetermined manner (e.g., the difference is less than a predetermined amount). In one embodiment, the verification of the subset of packages from the optical disk can be considered not successful if the calculated checksum and the retrieved checksum are not equivalent.

FIG. 7 illustrates a flow diagram of a verification of a set of packages. In one embodiment, verification method 700 is performed by pre-install verifier 340 of FIG. 3.

Referring to FIG. 7, at block 710, a set of packages is determined from the packages stored on an optical disk. In one embodiment, the packages can contain the software to be installed from the optical disk. In one embodiment, files on the optical disk can contain the software and these files may be compressed in the packages. In one embodiment, the packages can contain metainfo. In this embodiment, the metainfo can track the software to be installed and may also track the software that has already been installed. In one embodiment, each package may contain package information, which can describe the contents of the package. In one embodiment, the contents of the package can contain a payload, which can be the compressed representation of all software files to be installed. In one embodiment, the software can be an operating system. In one embodiment, the set of packages can include all packages on the optical disk. In an alternate embodiment, the set of packages can include a subset of the packages on the disk. In yet another embodiment, the set of packages can be a predetermined set of installer packages. In one embodiment, the installer packages stored on the optical disk are the only packages required by the operating system to install the software.

At block 720, the process retrieves a checksum for each of the packages in the set of packages. In one embodiment, the checksum can be retrieved from the optical disk as part of each package. In an alternate embodiment, the checksum can be retrieved from a different location on the optical disk than the package. In alternate embodiments, a representation of content other than a checksum may be used (e.g., a hash key, an error correction code, a cyclic redundancy check, a parity, etc) without departing from the scope of the invention.

At block 730, the process copies each package in the set of packages from the optical disk. The process continues to block 740 and calculates a checksum for each package in the set of packages.

At block 750, the calculated checksum from block 740 is compared to the retrieved checksum of block 720. In one embodiment, the copy of each package from the optical disk can be considered successful if the calculated checksum and the retrieved checksum are equivalent. In an alternate embodiment, the copy of each package from the optical disk can be considered successful if the calculated checksum and the retrieved checksum compares in a predetermined manner (e.g., the difference is less than a predetermined amount). In one embodiment, the copy of each package from the optical disk can be considered not successful if the calculated checksum and the retrieved checksum are not equivalent.

The steps in method 700 are presented only in an illustrative order. In alternate embodiments, a different order may be implemented without departing from the scope of the invention. For example, block 710 may continue to block 730, block 730 may continue to block 740, block 740 may continue to block 720, and block 720 may continue to block 750. In this example, one or more checksums for a set of packages can be retrieved from a copied package, instead of from an optical disk.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 400, 500, 600, and 700 in FIG. 4, FIG. 5, FIG. 6, and FIG. 7 respectively without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method for error detection during installation of software on a computer from an optical disk, the method comprising:
verifying a first set of packages on the optical disk, wherein the first set of packages comprises a subset of all packages on the optical disk, the verifying comprising:
calculating a first checksum for each package in the first set of packages, and
comparing the first checksum for each package in the first set of packages to a second checksum for each package in the first set of packages, wherein the second checksum for each package is obtained from the optical disk; and
responsive to successful verification of the first set of packages, verifying a second set of packages on the optical disk, the verifying comprising:
copying each package in the second set of packages to the computer from the optical disk, wherein each package in the second set of packages is associated with a third checksum,
calculating a fourth checksum for each package in the second set of packages, and
comparing the fourth checksum to the third checksum for each package in the second set of packages.

2. The method of claim 1, wherein verifying the second set of packages further comprises:
repeating the verifying for a package in the second set of packages if the fourth checksum does not compare in a predetermined manner to the third checksum for the package.

3. The method of claim 1, wherein verifying the second set of packages further comprises:
incrementing a failure count for a package if the fourth checksum does not compare in a predetermined manner to the third checksum for the package.

4. The method of claim 3, wherein verifying the second set of packages further comprises:
instructing a user to perform an action if the failure count for the package compares in a predetermined manner to a predefined number.

5. The method of claim 1, further comprising:
determining the first set of packages, wherein the first set of packages is identified in a header file stored on the optical disk.

6. The method of claim 5, wherein the header file comprises a table of contents that identities each of the first set of packages.

7. The method of claim 1, further comprising:
determining the first set of packages, wherein the first set of packages is identified in one or more scripts stored on the optical disk.

8. The method of claim 1, further comprising:
determining the second set of packages, wherein the second set of packages comprises a predetermined set of installer packages.

9. The method of claim 1, further comprising:
responsive to a successful verification of all packages in the second set of packages, restarting the computer on which the software is to be installed; and
installing the software utilizing the second set of packages copied onto the computer.

10. The method of claim 1, wherein the first set of packages is a subset of the second set of packages.

11. A method for error detection during installation of software from an optical disk to a computer, the method comprising:
calculating a first representation of content for each package in a first set of packages, wherein the first set of packages comprises a subset of all packages on the optical disk;
comparing the first representation of content for each package in the first set of packages to a second representation of content for each package in the first set of packages, wherein the second representation of content for each package is obtained from the optical disk;
proceeding with the installation of software from the optical disk in response to a successful comparison, wherein a successful comparison occurs if the first and second representations of content for each package in the first set of packages compare in a predetermined manner; and
aborting the installation of the software from the optical disk in response to one or more unsuccessful comparisons, wherein an unsuccessful comparison occurs if the first and second representations of content for one or more packages in the first set of packages do not compare in the predetermined manner.

12. The method of claim 11, wherein the first representation of content and the second representation of content are selected from the group consisting of: a hash key, an error correction code (ECC), a cyclic redundancy check (CRC), a checksum, and a parity.

13. The method of claim 11, further comprising:
incrementing a failure count for a package in response to an unsuccessful comparison; and
instructing a user of the optical disk to perform an action if the failure count for the package compares in a predetermined manner to a predefined number.

14. The method of claim 11, further comprising:
prior to proceeding with the installation of the software, verifying a second set of packages on the optical disk in response to a successful comparison for the first set of packages, the verifying comprising:
copying each package in the second set of packages from the optical disk, wherein each package in the second set of packages is associated with a third representation of content,
calculating a fourth representation of content for each package in the second set of packages, and
comparing the fourth representation of content to the third representation of content for each of the packages in the second set of packages.

15. The method of claim 14, wherein the third representation of content and the fourth representation of content are selected from the group consisting of: a hash key, an error correction code (ECC), a cyclic redundancy cheek (CRC), a checksum, and a parity.

16. A computer-readable storage medium comprising executable instructions to cause a processor to perform operations for error detection during installation of software from an optical disk to a computer, the instructions comprising:
verifying a first set of packages on the optical disk, wherein the first set of packages comprises a subset of all packages on the optical disk, the verifying comprising:
calculating a first checksum for each package in the first set of packages, and
comparing the first checksum for each package in the first set of packages to a second checksum for each package in the first set of packages, wherein the second checksum for each package is obtained from the optical disk; and
responsive to a successful verification of the first set of packages, verifying a second set of packages on the optical disk, the verifying comprising:
copying each package in the second set of packages to the computer from the optical disk, wherein each package in the second set of packages is associated with a third checksum,
calculating a fourth checksum for each package in the second set of packages, and
comparing the fourth checksum to the third checksum for each package in the second set of packages.

17. The computer-readable storage medium of claim 16, wherein verifying the second set of packages further comprises:
repeating the verifying for a package in the second set of packages if the fourth checksum does not compare in a predetermined manner to the third checksum for the package.

18. The computer-readable storage medium of claim 16, wherein verifying the second set of packages further comprises:
incrementing a failure count for a package if the fourth checksum does not compare in a predetermined manner to the third checksum for the package; and
instructing a user to perform an action if the failure count for the package compares in a predefined manner to a predefined number.

19. The computer-readable storage medium of claim 16, wherein the instructions further comprise:
determining the first set of packages, wherein the first set of packages is identified in a group consisting of: a header file and a script stored on the optical disk.

20. The computer-readable storage medium of claim 16, wherein the header file comprises a table of contents that identifies each of the first set of packages.

21. The computer-readable storage medium of claim 16, wherein the instructions further comprise:
determining the second set of packages, wherein the second set of packages comprises a predetermined set of installer packages.

22. The computer-readable storage medium of claim 16, wherein the instructions further comprise:
responsive to a successful verification of all packages in the second set of packages, restarting the computer on which the software is to be installed; and
installing the software utilizing the second set of packages copied onto the computer.

23. A computer-readable storage medium comprising executable instructions to cause a processor to perform operations for error detection during installation of software from an optical disk to a computer, the instructions comprising:
calculating a first representation of content for each package in a first set of packages, wherein the first set of packages comprises a subset of all packages on the optical disk;
comparing the first representation of content for each package in the first set of packages to a second representation of content for each package in the first set of packages, wherein the second representation of content for each package is obtained from the optical disk;
proceeding with the installation of software from the optical disk in response to a successful comparison, wherein a successful comparison occurs if the first and second representations of content for each package in the first set of packages compare in a predetermined manner; and
aborting the installation of the software from the optical disk in response to one or more unsuccessful comparisons, wherein an unsuccessful comparison occurs if the first and second representations of content for one or more packages in the first set of packages do not compare in the predetermined manner.

24. The computer-readable storage medium of claim 23, wherein the first representation of content and the second representation of content are selected from the group consisting of: a hash key, an error correction code (ECC), a cyclic redundancy check (CRC), a checksum, and a parity.

25. The computer-readable storage medium of claim 23, wherein the instructions further comprise:
incrementing a failure count for a package in response to an unsuccessful comparison; and
instructing a user of the optical disk to perform an action if the failure count for the package compares in a predetermined manner to a predefined number.

26. The computer-readable storage medium of claim 23, wherein the instructions further comprise:
prior to proceeding with the installation of software, verifying a second set of packages on the optical disk in response to a successful comparison for the first set of packages, the verifying comprising:
copying each package in the second set of packages from the optical disk, wherein each package in the subsequent set of packages is associated with a third representation of content,
calculating a fourth representation of content for each package in the second set of packages, and
comparing the fourth representation of content to the third representation of content for each of the packages in the second set of packages.

27. The computer-readable storage medium of claim 26, wherein the third representation of content and the fourth representation of content are selected from the group consisting of: a hash key, an error correction code (ECC), a cyclic redundancy check (CRC), a checksum, and a parity.

28. An apparatus comprising:
means for verifying a first set of packages, wherein the first set of packages comprises a subset of all packages on an optical disk, the verifying comprising:
means for calculating a first checksum for each package in the first set of packages, and
means for comparing the first checksum for each package in the first set of packages to a second checksum for each package in the first set of packages, wherein the second checksum for each package is obtained from the optical disk; and
means for verifying a second set of packages on the optical disk responsive to successful verification of the first set of packages, the verifying comprising:
means for copying each package in the second set of packages to a computer from the optical disk, wherein each package in the second set of packages is associated with a third checksum,
means for calculating a fourth checksum for each package in the second set of packages, and
means for comparing the fourth checksum to the third checksum for each package in the second set of packages.

29. An apparatus comprising:
means for calculating a first representation of content for each package in a first set of packages, wherein the first set of packages comprises a subset of all packages on an optical disk;
means for comparing the first representation of content for each package in the first set of packages to a second representation of content for each package in the first set of packages, wherein the second representation of content for each package is obtained from the optical disk;
means for proceeding with the installation of the software from the optical disk in response to a successful comparison, wherein a successful comparison occurs if the first and second representations of content for each package in the first set of packages compare in a predetermined manner; and
means for aborting the installation of the software from the optical disk in response to one or more unsuccessful comparisons, wherein an unsuccessful comparison occurs if the first and second representations of content for one or more packages in the first set of packages do not compare in the predetermined manner.

30. A computer system comprising:
a memory; and
a processor configurable by instructions stored in the memory to:
verify a first set of packages selected from all packages on an optical disk, the verify comprising:
calculating a first checksum for each package in the first set of packages, and
comparing the first checksum for each package in the first set of packages to a second checksum for each package in the first set of packages, wherein the second checksum for each package is obtained from the optical disk; and
verify a second set of packages on the optical disk if the verification of the first set of packages was successful, the verify comprising:
copying each package in the second set of packages to the computer system from the optical disk, each package in the second set of packages including a third checksum,
calculating a fourth checksum for each package in the second set of packages, and
comparing the fourth checksum to the third checksum for each of the packages in the second set of packages.

31. A computer system comprising:
a memory and
a processor configurable by instructions stored in the memory to:
calculate a first representation of content for each package in a first set of packages, wherein the first set of packages comprises a subset of all packages on an optical disk;
compare the first representation of content for each package in the first set of packages to a second representation of content for each package in the first of packages, wherein the second representation of content for each package is obtained from the optical disk;
proceed with an installation of software from the optical disk in response to a successful comparison, wherein a successful comparison occurs if the first and second representations of content for each package in the first set of packages compare in a predetermined manner; and
abort the installation of software from the optical disk in response to one or more unsuccessful comparisons, wherein an unsuccessful comparison occurs if the first and second representations of content for one or more packages in the first set of packages do not compare in the predetermined manner.
